(19) United States
(12) Patent Application Publication
(10) Pub. No.: US 2024/0310619 A1
(43) Pub. Date: Sep. 19, 2024

(54) AUTOMATED MICROSCOPY

(71) Applicant: UCL BUSINESS LTD, London Greater London (GB)

(72) Inventors: Petru MANESCU, London Greater London (GB); Delmiro FERNANDEZ-REYES, London Greater London (GB)

(21) Appl. No.: 18/257,389

(22) PCT Filed: Dec. 7, 2021
(86) PCT No.: PCT/GB2021/053189

§ 371 Date: Jun. 14, 2023

(30) Foreign Application Priority Data
Dec. 16, 2020 (GB) 2019920.4

(51) Int. Cl. G02B 21/36; G02B 21/26; G06T 7/00; G06V 20/69

(52) U.S. Cl. CPC G02B 21/367; G02B 21/26; G06T 7/0012; G06V 20/693; G06T 2207/10056; G06T 2207/20081; G06T 2207/20084

(57) ABSTRACT

A computer implemented method of controlling a microscope (632) is provided. The method comprises capturing an image (631) within a field of view of a lens of the microscope (632) configured to view a sample on a motorised stage (633) of the microscope (632). The image comprises a portion of the sample. The image (631) is provided to an artificial neural network (610). An action (611) for moving the motorised stage (633) is determined in dependence on an output of the artificial neural network (610). The motorised stage (633) is moved automatically in accordance with the action (611).

### TECHNICAL FIELD

The present invention relates to a computer implemented method of controlling a microscope. The invention also relates to a system for capturing images.

### BACKGROUND

In the field of microscopy, it is known to analyse a sample of particles, i.e. microscopic objects such as cells or solid fragments of a substance, comprising one or more regions in which particles are grouped together. In order to properly analyse the sample, it may be necessary to locate one or more regions for further analysis in which the particles are suitably separated from one another (for example so that the morphology of the objects can be investigated). One example where this may be required is blood film analysis.

In order to properly analyse a blood film, for example to diagnose blood related disorders or infections, it may be required to identify specific regions of the blood film for further analysis in which the blood cells are suitably separated and suitable for further morphological analysis. In some regions there will be agglomerations or clumps of overlapping cells, in which individual cells are hard to distinguish. In some regions there will be very thin areas, in which cells may be distorted.

In the example of blood film analysis, a microscope with a high spatial resolution is typically required in order to provide images from which different cell features can be distinguished. The requirement for high spatial resolution typically results in a limited field of view. This means that it may be required to capture images of many different regions of the blood film in order to analyse a suitable volume of blood. The sample is typically placed on a mobile stage which is moveable relative to the field of view of the microscope. A skilled microscopist controls the movement of the stage, and will capture images of specific fields of view that are suitable for further analysis.

It would be desirable to improve the throughput of particle analysis, and reduce dependency on analysis by a skilled microscopist. Capturing a high-resolution image of the entire sample is not be practical, because this will take a long time and produce a large amount of data, which is impractical and expensive to maintain.

### SUMMARY OF INVENTION

An aspect of the invention provides a computer implemented method of controlling a microscope. The method comprises: capturing an image within a field of view of a lens of the microscope configured to view a sample on a motorised stage of the microscope, the image comprising a portion of the sample; providing the image to an artificial neural network; determining an action for moving the motorised stage in dependence on an output of the artificial neural network; and automatically moving the motorised stage in accordance with the action.

The moving of the motorised stage may be to select a different field of view (e.g. in a direction substantially parallel to a focal plane of the lens).

The sample may comprise particles that have a gradient of number density. The particles may comprise blood cells or other objects of interests to a pathologist.

According to a second aspect, there is provided a method of performing automated blood film smear analysis, comprising using the method of any preceding claim to capture good regions of a blood smear for subsequent analysis.

The method may comprise performing automatic analysis of images of the good regions of the blood smear.

The artificial neural network may have been trained using reinforcement learning, and may be configured to estimate an action that will maximise a cumulative future reward.

The artificial neural network may have been trained using a Q-learning algorithm.

The artificial neural network may comprise a convolutional neural network. The convolutional neural network may comprise at least two convolutional layers. The artificial neural network may comprise a final fully connected layer. The artificial neural network may comprise a long-short term memory cell.

The method may comprise repeating the steps of capturing an image, providing the image to the artificial neural network, determining an action for moving the motorised stage and automatically moving the motorised stage until a predetermined criterion is met.

The predetermined criterion may be based on a number of images captured that are classified as suitable for further morphological analysis (referred to as good images).

The method may comprise providing the image to a further artificial neural network configured to score the image for suitability for subsequent analysis.

The method may comprise classifying a captured image as a good image if the score from the further artificial neural network exceeds a threshold score.

The predetermined criterion may be met when a predetermined number of good images have been captured.

The method may further comprise automatically analysing the good images (e.g. only the good images—the images that are not good may be discarded, for example which improves computational and storage throughput.

Capturing an image may comprise capturing a series of images with different focus and combining or stacking the series of images to form an image with increased depth of field.

According to a third aspect, there is provided a system for capturing images, comprising:
a microscope comprising a lens and a motorised stage, wherein the lens is configured to view a sample on the motorised stage;
a camera configured to capture an image within a field of view of the lens, the image comprising a portion of the sample; and
a processor; wherein
the processor is configured to:
   provide a control signal instructing the camera to capture the image;
   provide the image to an artificial neural network;
   determine an action for moving the motorised stage in dependence on an output of the artificial neural network; and
   provide a control signal instructing the motorised microscope stage to move in accordance with the action.

The system according to the third aspect may be configured to perform the method of the first and/or second aspect, including any of the optional features thereof.

### DETAILED DESCRIPTION

Example embodiments will be described, with reference to the accompanying drawings, in which:

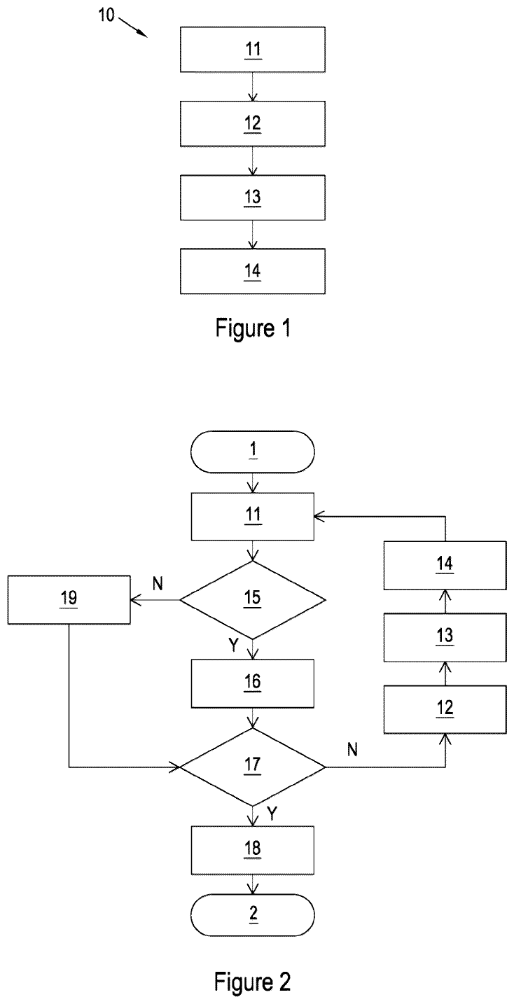

FIG. 1 is flow diagram of a method for automatically moving a microscope stage according to the invention;

FIG. 2 is a flow diagram of a method for automatically capturing good fields of view and subsequently analysing them;

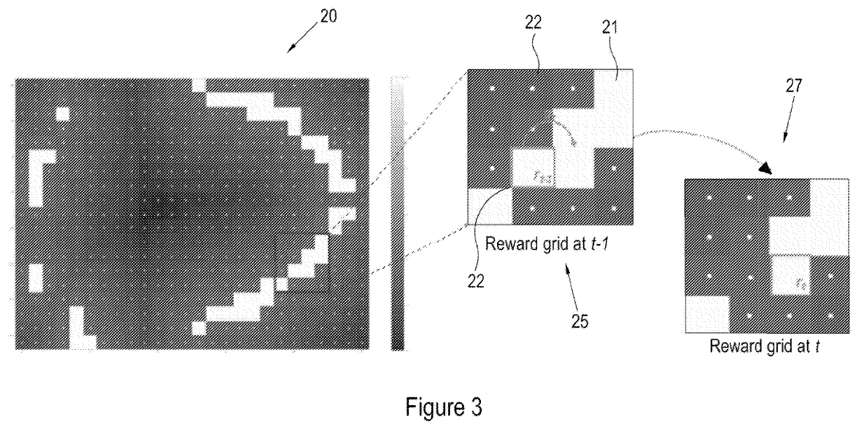

FIG. 3 shows a reward grid for training an artificial neural network to approximate an optimal action-value function for moving a microscope stage;

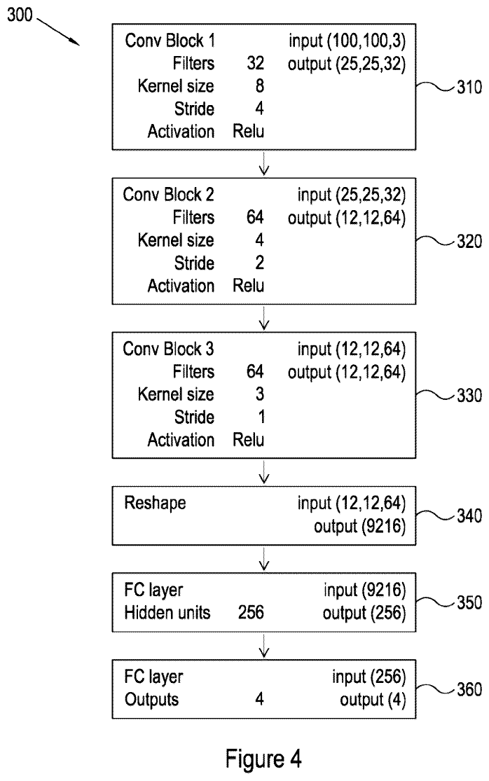

FIG. 4 is a schematic of an architecture for an artificial neural network for determining a movement direction from an image;

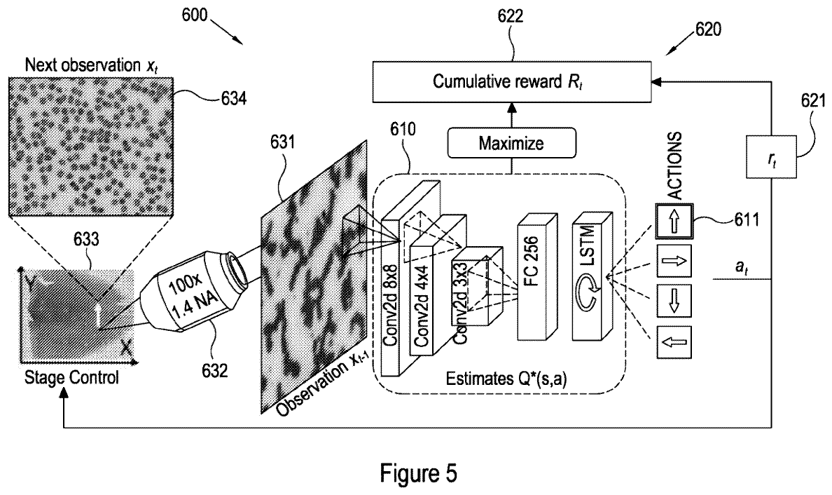

FIG. 5 shows an overview of a system according to an embodiment, for automatically controlling a microscope to obtain good images for subsequent analysis;

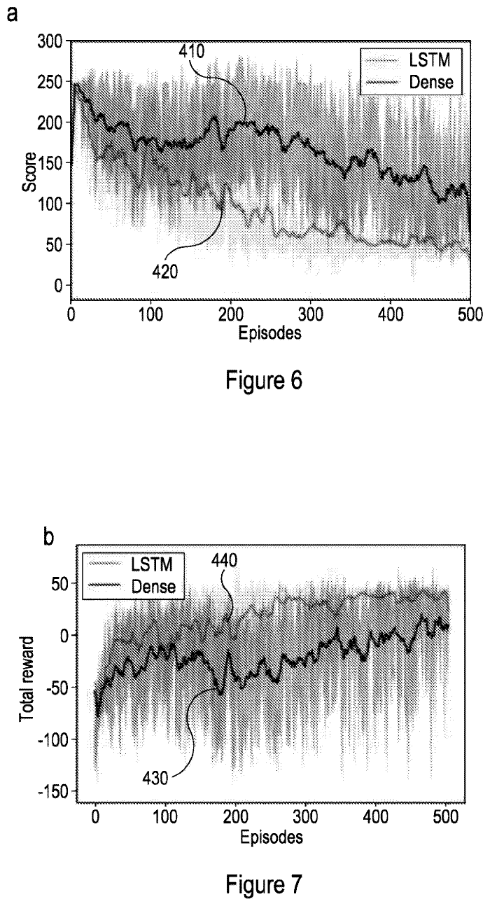

FIGS. 6 and 7 show results of training an example artificial neural network for use in an embodiment;

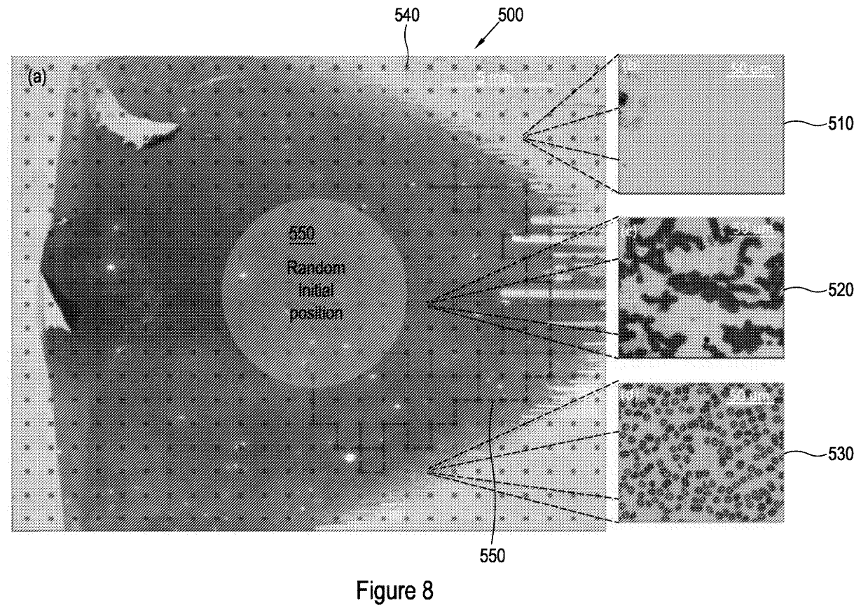

FIG. 8 shows an unseen blood smear that was used to test the performance of a trained system according to an embodiment;

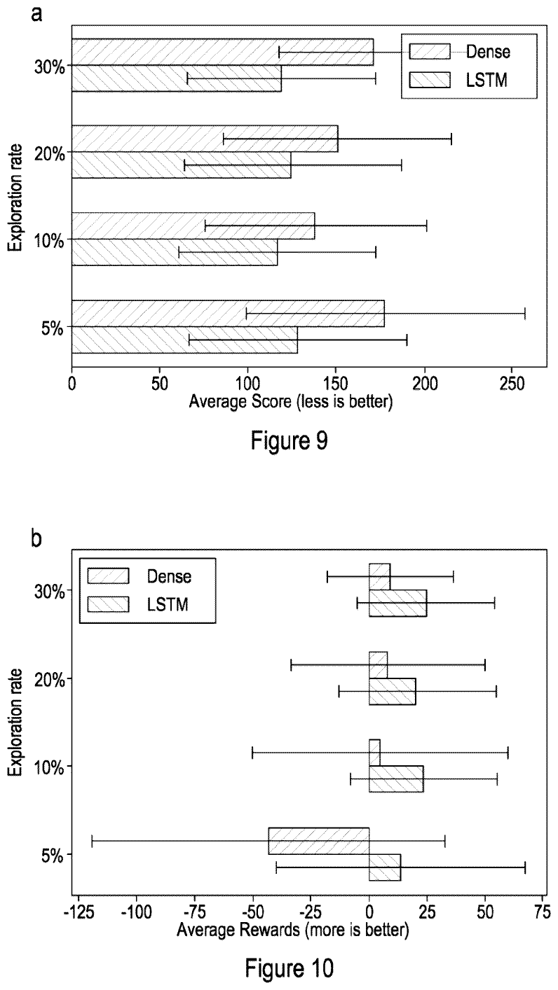

FIGS. 9 and 10 show results obtained according to an embodiment, with differing exploration rates; and

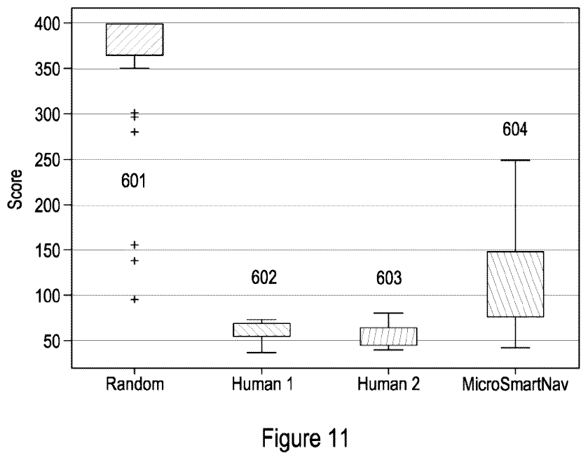

FIG. 11 compares results obtained from the example embodiment with random movement of the microscope stage, and with two trained human microscopists.

As discussed in the background section, in blood cell analysis a high spatial resolution is required to distinguish different cell features, which may be indicative of a particular pathology. The need for a high spatial resolution means that high numerical aperture lenses are typically required, which provide only a narrow field of view. As an example, the WHO (World Health Organisation) recommends the inspection of at least 5000 erythrocytes under a high magnification objective lens (100×/1.4NA) to diagnose and quantify malaria in thin blood smears. Assuming a typical microscope field of view (FoV) of 140 microns×140 microns and an erythrocyte number density of 150-200 (per FoV area of 140×140 microns), this requires between 20 and 30 non-overlapping FoVs. Finding these “good” regions typically requires visual inspection and manual operation of the microscope stage, which is slow, prone to inadequate sampling, and requires a trained microscopist.

A brute-force solution would be to image the whole blood smear at high magnification and then discard portions of it that are not suitable for further analysis. However, in the context of blood smear analysis this approach would typically require capturing thousands of FoVs. In general, this approach is slow and wasteful of storage resources (making it unsuitable for high throughput analysis).

A similar problem may exist in other fields. For example, in any analysis of particle morphology (e.g. in a colloid that has been spread into a thin-film for analysis), it may be necessary to obtain images of particles with a suitable amount of dispersion, so that there are both enough samples to analyse and that individual particles can readily be distinguished (i.e. with relatively few or no overlapping particles). In many samples there will be one or more gradients of particle number density.

To overcome this problem, the inventors have appreciated that machine learning and artificial intelligence can be employed to control the movement of the stage of the microscope (rather than simply being used to analyse images that are obtained from a brute-force approach, which has been the approach used hitherto). In embodiments, an image obtained by a microscope is provided to an artificial neural network (ANN). The ANN been trained to determine how to move the stage in order to find good regions for further analysis and an action for moving the motorised stage can consequently be determined from the output of ANN. The stage can automatically be moved based on the action and a new image obtained. This process can be repeated, which will result in the stage automatically being moved to find and capture good regions of the sample that is on the stage. The stage can be moved and images captured until a predetermined number of suitable (good) images (or fields of view) have been captured. This approach is particularly suitable for high-throughput automatic analysis of blood smears.

The present inventors have appreciated that the visual clues may be present in each field of view as to how to move the microscope stage in order to maximise the efficiency of a search for good regions. In a blood smear, there may be one or more gradients in the density of the cells. For example, the smear may be too thick near a central region and too thin in peripheral regions. The good regions may be restricted to a specific band between the periphery and a central region. It is therefore possible for an ANN to observe whether there is a gradient in the density of blood cells at each location (and to determine if blood cells are getting more dense or less dense as the stage is moved) and intelligently operate the stage to find, and remain within, good regions.

Referring to FIG. 1, a computer implemented method 10 is shown for controlling a microscope. At step 11 an image is captured of a region of a sample (e.g. with an objective lens with at least 50× magnification and/or a NA of at least 1). The sample is on a motorised stage of the microscope (and may be a blood film on a slide, or some other sample comprising particles). At step 12 the image is provided to an artificial neural network (ANN). At step 13, an action for moving the motorised stage is determined, in dependence on an output from the ANN, produced in step 12. At step 14, the motorised stage is automatically moved in accordance with the action.

Steps 11 to 14 may be repeated until a predetermined criterion has been satisfied. For example, steps 11 to 14 may be repeated until a predetermined number of good FoVs have been captured.

An algorithm may be used to assess whether each captured FoV is a good FoV that is suitable for further analysis. The algorithm for assessing whether each FoV is a good FoV may comprise an ANN that has been trained to recognise good FoVs. This is essentially an image classification task, which is particularly well suited for a convolution neural network (for example trained by gradient descent, with a hand classified training set and a penalty function based on the accuracy of the classification produced by the neural network).

FIG. 2 schematically illustrates a method for obtaining good FoVs from a sample, which optionally includes a step of analysing each good FoV. Start and end points are indicated by 1 and 2 respectively. At step 11, an image is captured of the current field of view (e.g. in a central region of the sample). At step 15, the current FoV may be provided to a classifying ANN, which determines whether the current FoV is good (suitable for further analysis) or bad (not suited for analysis). If the current FoV is classified bad, it is tagged, in step 19, as a bad FoV. Bad FoV images can be discarded after they have been provided to the ANN in step 12.

If the current FoV is classified good, it is tagged, in step 16, as a good FoV and stored, ready for subsequent analysis. In step 17, the number of good FoVs is compared with a predetermined threshold number of good FoVs. If the number of good FoVs is equal to or greater than the threshold number of FoVs, there are enough to analyse and the method can proceed to optional step 18, in which the good FoVs are analysed. If there are not sufficient good FoVs at step 17, the current FoV is provided to an ANN at step 12. The ANN determines, in step 13, a movement action for automatically moving the motorised stage of the microscope to select a new (different) FoV to capture. At step 14 the motorised stage automatically moves in response to the movement action determined in step 14, and a new FoV is captured back at step 11.

According to this method, a microscope can be fully automatically controlled to efficiently capture sufficient good FoVs for a meaningful analysis (e.g. of a blood film), and then may automatically carry out the analysis. In some embodiments the step 18 may be carried out by a clinician (rather than by a computer implemented algorithm). In either case, the automatic capturing of sufficient good FoVs for analysis in this way is very useful for increasing throughput and reducing the total cost of analysis making the deployment of these system suitable for clinical use.

The ANN for determining a movement action may be trained to provide an output that determines an appropriate movement action for the motorised stage that is likely to find good regions of the sample for further analysis. In principle, the ANN may be trained in a number of ways, but reinforcement learning is a particularly appropriate technique for training a neural network to determine an optimal series of movement actions for efficiently finding good regions based on image information.

In reinforcement learning, an algorithm is trained to select a sequence of actions that maximise a long-term gain (or cumulative reward) by interacting with an environment whose description is learned from the raw data that is provided to the algorithm. In the present case, the algorithm comprises an artificial neural network, such as a convolutional neural network (e.g. with one or two or more hidden layers), and the raw data comprises image data (or data derived from image data).

The ANN can be considered an agent, which interacts with the environment (i.e. microscope) through a sequence of observations, actions and rewards. The agent observes an image (xₜ₋₁), corresponding with the image captured the current field of view. The agent then calculates weights corresponding with each possible action (αₜ) from the set of possible actions (e.g. UP, LEFT, DOWN, RIGHT). The highest weight can be selected as corresponding with the action that is likely to produce the highest cumulative reward. During training of the ANN, the agent receives a reward rₜ (defined in more detail below) and observes the image xₜ, at the new field of view, and the process repeats. The ANN is trained with the goal of choosing the actions that maximise the cumulative future reward Rₜ=rₜ+γ·rₜ₊₁+γ²·rₜ₊₂+ . . . where γ is a discount factor. To train the ANN, a Q-learning algorithm may be used, that learns navigation strategies from sequences of actions and observations, sₜ=x₁, α₁, x₁, α₁, . . . αₜ₋₁, xₜ.

More precisely, a CNN can be trained to approximate the optimal action-value function:

$$Q * ( s , a ) = {max}_{π} 𝔼 [ {R}_{t} \vert {s}_{t} = s , {a}_{t} = a , π ] \qquad ( 1 )$$

which translates into maximising the cumulative reward achievable by policy π, after taking an action α based on an observation s. In practice, the policy π will be encoded in the weights of the trained neural network.

For training the ANN, at least one sample can be completely imaged, to produce a set of FoVs. The FoVs can be reviewed and labelled, for example by a trained microscopist, as good FoVs (suitable for further analysis) and bad FoVs (not suitable for further analysis).

During training of the ANN, a constant positive reward is accumulated if the agent moves the stage to a good FoV, while a negative reward is accumulated if the agent moves the stage to a FoV that is a bad FoV. The magnitude of the negative reward may be proportional to the distance from the current position to the nearest good FoV. A negative reward for a bad FoV will thereby be higher further away from the nearest good FoV.

FIG. 3 shows a reward grid 20 for training an ANN to approximate the optimal action-value function. The sample in this example is a blood smear, which is divided into a grid of 20×25 166 micron×142 micron FoVs, with a centre to centre separation of 1.12 mm in the X direction and 1.05 mm in the Y direction. Each FoV is therefore non-contiguous with the other FoVs. At each XY position a focal series (z-stack) of 15 focal planes was acquired and projected into a single image using a wavelet-based extended depth of field algorithm.

The lighter coloured squares 21 represent good FoVs that have been labelled by the trained microscopist as containing red blood cells at a number density suitable for subsequent analysis. The other (darker coloured) FoVs 22 are bad, with the darker FoVs (far from any good FoVs, in the centre for example) having larger negative rewards than bad FoVs near to the good FoVs (around the edges of the sample, for example).

To avoid the agent being stuck in one single region of the sample (e.g. going backward and forward to the same good FoV), once the agent has visited a good FoV, that FoV is labelled as a bad FoV. The box 22 indicates the position of the agent on the grid. At time t−1 the agent determines that RIGHT is the optimal move. This results in another good FoV being selected at time t, and the previous grid location has been marked as a bad FoV. The agent may also receive a negative reward if it moves to a previously visited location on the grid.

FIG. 4 shows an example ANN architecture 300 that is suitable for use in an embodiment. This example is merely illustrative, and it will be appreciated that different architectures may also be used (for example, employing different hyperparameters such as: numbers of layers, convolution kernel dimensions, strides, dilated convolutions, activation functions, pooling etc).

The first convolution layer 310 comprises a 2D convolution layer followed by a rectified linear activation layer (which may be referred to as a relu). In this example, the input dimensions of the data are (100,100,3): corresponding with an RGB image with 100×100 pixels. The input data provided to the ANN may comprise image data after it has been resized and/or normalised.

The first convolution layer 310 has 32 filters with 8×8 kernel size and a stride of 4. The second convolution layer 320 again comprises a 2D convolution layer followed by a relu. In this layer there are 64 filters with a 4×4 kernel size and a stride of 2. The third convolution layer 330 again comprises a 2D convolution layer followed by a relu. The third convolution layer 330 has 64 filters with a 3×3 kernel size and a stride of 1.

The output from the third convolution layer 330 is reshaped to a vector in layer 340, then the vector is provided to a first fully connected layer 350, which has 256 hidden units. The output from the first fully connected layer 350 is provided to a final fully connected layer 360, which has four output units, respectively corresponding with the four directions UP, LEFT, DOWN, RIGHT.

In some embodiments, the final layer 350 can be replaced with a long-short term memory (LSTM) cell, which may be advantageous (as will be shown in more detail with reference to the example).

FIG. 5 shows an overview of a system 600 according to an embodiment, comprising an ANN 610 (e.g. as described with reference to FIG. 3). The ANN 610 is depicted with a LSTM cell for the final layer. It will be appreciated that other ANNs may be used in place of the example architecture shown. The ANN 610 receives an observation in the form of image data 631 from microscope 632. The ANN 610 determines an action at from the four different action options 611, using a policy that has been trained to maximise cumulative reward Rₜ 622. The action at is used to determine how to move the stage 633, in order to capture the next observation 634.

An example embodiment was trained using the data illustrated in FIG. 3. At each time step, the observation xₜ is a random crop of 1024×1024×3 pixels from the full frame image at each location (2160×2560×3 pixels), resized to 100×100×3 pixels and normalised. This was provided as an input to the example ANN shown in FIG. 4, and the weights in the ANN optimised with an Adam optimiser. The model was trained for 500 episodes. In each training episode, the agent started at a random position around the centre of the grid (+/−3FoV positions in x and y directions). During training, an episode ended if 20 good FoVs were visited, or alternatively, if the agent visited a total of 250 FoVs. A replay batch size of 32, and a learning rate of 10⁻⁴ was used. At each step, the movement direction was selected by choosing between the action suggested by the ANN (i.e. the direction with the highest weight) and exploring the environment with a randomly selected movement direction. During training, the exploration rate (probability to choose a random action) decayed from 1.0 to a minimum value of 0.05 with a decay rate of 0.9995 per step. At the start of training, the exploration rate is 1 and at the second step of the first episode it is 0.9995. With each episode of training, the exploration rate gradually reduces to a minimum of 0.05.

The performance improvement of the ANN is shown with increasing training episode in FIGS. 6 and 7. FIG. 6 shows a moving average (averaged over 5 episodes) of the score: 410 with a fully connected layer as the final layer, 420 with a long term short term memory (LSTM) cell as the final layer. The score is the number of locations visited in each episode (before the end criteria is reached). A lower score therefore indicates better performance, since fewer locations are visited. The moving average score for the LSTM architecture outperforms that for an architecture with a fully connected final layer at all times during training. FIG. 7 shows a moving average (averaged over 5 episodes) of the total reward: 430 with a fully connected layer as the final layer, 440 with a LSTM cell as the final layer. The LSTM based architecture outperforms the fully connected layer based architecture by this measure too.

The trained ANN (according to the architecture described with reference to FIG. 4) was tested on an unseen blood smear 500, as shown in FIG. 8. The FoVs 540 are shown, along with region of starting positions 550 (selected in the same way as described with reference to training). Inset images 510, 520, 530 respectively show examples of a bad FoV (with too low cell number density), good FoV, and a bad FoV (with too high cell number density). Example paths 560 taken in dependence of the output from the trained ANN are shown.

Results of testing the trained model on the unseen test blood smear are shown in FIGS. 9 and 10. One hundred episodes were tested, each with random starting points within the starting position region 500. FIG. 9 shows the average score (number of FoVs explored in order to locate 20 unique good FoVs) for exploration rates of 5%, 10%, 20% and 30%. The exploration rate is the probability of choosing a random direction instead of the highest scoring direction determined from the ANN. FIG. 10 shows the average rewards for the same range of exploration rates. In both FIGS. 8 and 9, the scores and rewards are shown for architectures employing and LSTM cell as the final layer and a fully connected final layer.

In the example embodiment, an exploration rate of 10% achieves the best scores for both LSTM and fully connected final layers. This may be explained by the fact that the test grid is new to the agent, which has to explore more than during training. The results demonstrate that an agent employing an ANN (for example, trained using Q-learning and employing a deep convolutional neural network) has the ability to generalise and navigate through different unseen blood smears, even trained using a single smear. This is despite the inherent different in appearance and thickness between samples due to the variability in sample preparation.

FIG. 11 shows a comparison of results from the example ANN controlled microscope stage 604 with two different human obtained results 602, 603. On average the machine learning controlled approach 604 requires twice as many steps to acquire 20 unique good FoVs, when compared with human obtained results. This is markedly better than results obtained from a random navigation control algorithm 601.

Although an example embodiment has been described in which blood cells are analysed, it will be understood that the same approach can be used on other particulate samples, especially where there is one or more gradient in the number density of particles, and separation between particles is important for subsequent analysis. Such a variation in gradient in sample density may result from, for example, variations in a dispersion pattern of particles for analysis.

Other variations are possible, which are intentionally within the scope of the invention, defined by the appended claims.

What is claimed is:

1. A computer implemented method of controlling a microscope, comprising:
capturing an image within a field of view of a lens of the microscope configured to view a sample on a motorised stage of the microscope, the image comprising a portion of the sample;
providing the image to an artificial neural network;
determining an action for moving the motorised stage to select a different field of view in dependence on an output of the artificial neural network; and
automatically moving the motorised stage in accordance with the action.

2. The method of claim 1, wherein the sample comprises particles that have a gradient of number density.

3. The method of claim 1, wherein the particles comprise blood cells.

4. A method of performing automated blood smear or film analysis, comprising using the method of claim 1, to capture good regions of a blood smear for subsequent analysis.

5. The method of claim 4, further comprising performing automatic analysis of images of the good regions of the blood smear.

6. The method of claim 1, wherein the artificial neural network has been trained using reinforcement learning, and is configured to estimate an action that will maximise a cumulative future reward.

7. The method claim 1, wherein the artificial neural network has been trained using a Q-learning algorithm.

8. The method of claim 1, wherein the artificial neural network comprises a convolutional neural network.

9. The method of claim 8, wherein the convolutional neural network comprises at least two convolutional layers.

10. The method of claim 1, wherein the artificial neural network comprises a final fully connected layer.

11. The method of claim 10, wherein the artificial neural network comprises a long-short term memory cell.

12. The method of claim 1, comprising repeating the steps of capturing an image, providing the image to the artificial neural network, determining an action for moving the motorised stage and automatically moving the motorised stage until a predetermined criterion is met.

13. The method of claim 12, wherein the predetermined criteria is based on a number of images captured that are classified as good.

14. The method of claim 1, comprising providing the image to a further artificial neural network configured to score the image for suitability for subsequent analysis.

15. The method of claim 14, comprising classifying a captured image as a good image if the score from the further artificial neural network exceeds a threshold score.

16. The method of claim 1, comprising:
i) repeating the steps of capturing an image, providing the image to the artificial neural network, determining an action for moving the motorised stage and automatically moving the motorised stage until a predetermined criterion is met, wherein the predetermined criteria is based on a number of images captured that are classified as good, wherein the predetermined criterion is met when a predetermined number of good images have been captured; and
ii) providing the image to a further artificial neural network configured to score the image for suitability for subsequent analysis and classifying a captured image as a good image if the score from the further artificial neural network exceeds a threshold score.

17. The method of claim 15, further comprising automatically analysing only the good images.

18. The method of claim 1, wherein capturing an image comprises capturing a series of images with different focus and combining or stacking the series of images to form an image with increased depth of field.

19. A system for capturing images, comprising:
a microscope comprising a lens and a motorised stage, wherein the lens is configured to view a sample on the motorised stage;
a camera configured to capture an image within a field of view of the lens, the image comprising a portion of the sample; and
a processor; wherein
the processor is configured to:
provide a control signal instructing the camera to capture the image;
provide the image to an artificial neural network;
determine an action for moving the motorised stage in dependence on an output of the artificial neural network; and
provide a control signal instructing the motorised microscope stage to move in accordance with the action.

20. The system of claim 19, configured to perform a method comprising:
capturing an image within a field of view of a lens of the microscope configured to view a sample on a motorised stage of the microscope, the image comprising a portion of the sample;
providing the image to an artificial neural network;
determining an action for moving the motorised stage to select a different field of view in dependence on an output of the artificial neural network;
automatically moving the motorised stage in accordance with the action.
repeating the steps of capturing an image, providing the image to the artificial neural network, determining an action for moving the motorised stage and automatically moving the motorised stage until a predetermined criterion is met, wherein the predetermined criteria is based on a number of images captured that are classified as good, wherein the predetermined criterion is met when a predetermined number of good images have been captured; and
providing the image to a further artificial neural network configured to score the image for suitability for subsequent analysis and classifying a captured image as a good image if the score from the further artificial neural network exceeds a threshold score.
